(19) United States
(12) Patent Application Publication
(10) Pub. No.: US 2011/0285505 A1
(43) Pub. Date: Nov. 24, 2011

(54) ELECTRONIC SHELF LABEL CONTROL APPARATUS AND METHOD

(75) Inventor: Shuichi Ogura, Shizuoka (JP)

(73) Assignee: TOSHIBA TEC KABUSHIKI KAISHA, Tokyo (JP)

(21) Appl. No.: 13/096,157

(22) Filed: Apr. 28, 2011

(30) Foreign Application Priority Data
May 18, 2010 (JP) 2010-114687

(51) Int. Cl. G08B 5/22

(52) U.S. Cl. 340/6.1

(57) ABSTRACT

According to one embodiment, an apparatus includes an article information detecting unit, an identification information detecting unit, and a distribution unit. The article information detecting unit detects article information displayed on the electronic shelf labels specified by shelf label identification information. The identification information detecting unit detects group identification information to identify whether articles having the article information displayed on the electronic shelf labels specified by the shelf label identification information belong to a same group or not. The distribution unit distributes display attribute information to differentiate display forms of the article information between articles belonging to the same group and articles that do not belong to the same group, to the electronic shelf label specified by the shelf label identification information corresponding to the article information of each of the articles identified as articles belonging to the same group from based on the group identification information.

### CROSS-REFERENCE TO RELATED APPLICATIONS

This application is based upon and claims the benefit of priority from Japanese Patent Application No. 2010-114687, filed on May 18, 2010, the entire contents of which are incorporated herein by reference.

### FIELD

Embodiments described herein relate generally to an apparatus and method for controlling display of an electronic shelf label.

### BACKGROUND

Supermarkets employ a sales method called mix and match (hereinafter referred to as an M&M method). In this method, when a designated number of articles are purchased in bulk, from among plural items of articles that are selected in advance, a special price is applied to the total price.

In the case of displaying the article name, unit price and the like of an M&M target article on an electronic shelf label used in an electronic shelf label system, the display form is the same as on an electronic shelf label of a non-target article. Therefore, simply by looking at an electronic shelf label, the customer cannot be informed of whether the article displayed on the label is an M&M target article or not.

### BRIEF DESCRIPTION OF THE DRAWINGS

FIG. 1 shows the overall configuration of an electronic shelf label system as an embodiment.

FIG. 2 is a schematic diagram showing the data structure of article setting information stored in an article information database in the system.

FIG. 3 is a schematic diagram showing the data structure of shelf label setting information stored in a shelf label information database in the system.

FIG. 4 is a plan view of an electronic shelf label used in the system.

FIG. 5 is a block diagram of the electronic shelf label.

FIG. 6 is a block diagram of a shelf label server used in the system.

FIG. 7 shows an example of a conversion table stored in the shelf label server.

FIG. 8 is a schematic diagram showing the structure of shelf label display data transmitted to the electronic shelf label from the shelf label server.

FIG. 9 is a flowchart showing essential parts of processing procedures executed by a CPU of the shelf label server according to an electronic shelf label control program.

FIG. 10A and FIG. 10B are plan views showing an example of a first screen displayed on the electronic shelf label in the first embodiment.

FIG. 11 is a plan view showing an example of a second screen displayed on the electronic shelf label in the first embodiment.

FIG. 12A and FIG. 12B are plan views showing an example of the first screen displayed on the electronic shelf label in a third embodiment.

FIG. 13A and FIG. 13B are plan views showing an example of the first screen displayed on the electronic shelf label in a fourth embodiment.

### DETAILED DESCRIPTION

In general, according to one embodiment, an electronic shelf label control apparatus includes an article information detecting unit, an identification information detecting unit, and a distribution unit. The article information detecting unit detects, according to each shelf label identification information to specify plural electronic shelf labels individually, article information displayed on the electronic shelf labels specified by the shelf label identification information. The identification information detecting unit detects, according to each shelf label identification information, group identification information to identify whether articles having the article information displayed on the electronic shelf labels specified by the shelf label identification information belong to a same group or not. The distribution unit distributes display attribute information to differentiate display forms of the article information between articles belonging to the same group and articles that do not belong to the same group, to the electronic shelf label specified by the shelf label identification information corresponding to the article information of each of the articles identified as articles belonging to the same group from based on the group identification information.

### First Embodiment

In this embodiment, an electronic shelf label control apparatus is applied to a shelf label server 1 of an electronic shelf label system 100. The electronic shelf label system 100 is constructed in a supermarket employing a sales method called an M&M method.

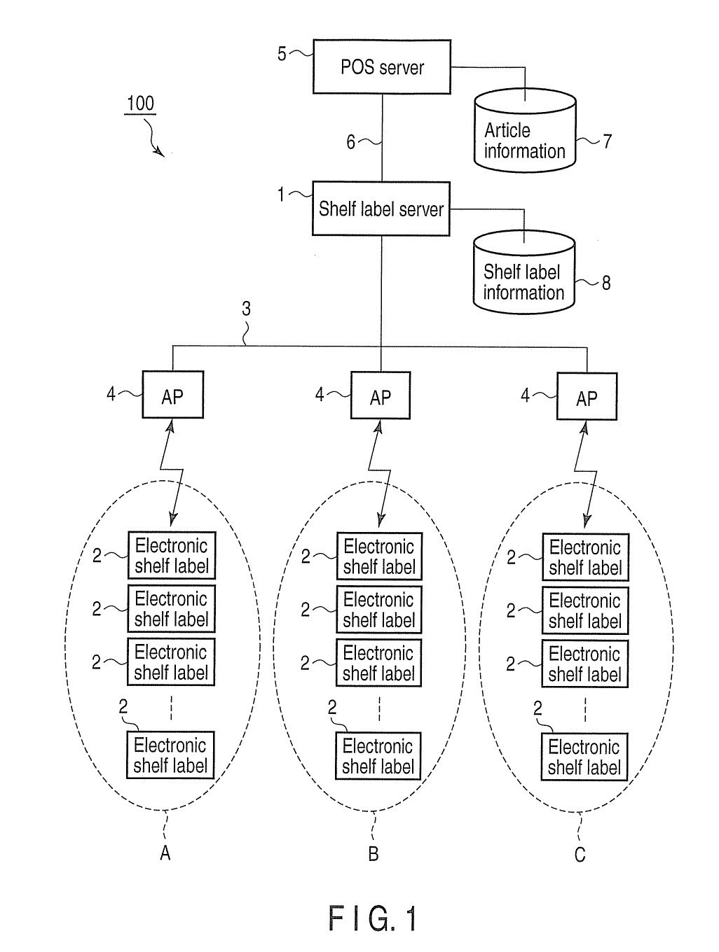

FIG. 1 shows the overall configuration of the electronic shelf label system 100. This system 100 includes the shelf label server 1 and plural electronic shelf labels 2 on which information received from the shelf label server 1 is displayed. The shelf label server 1 connects to plural (in FIG. 1, three) wireless base stations 4 via a first network 3. The shelf label server 1 also connects to a POS server 5 via a second network 6.

Each electronic shelf label 2 is attached to a front part of a shelf, corresponding to each article placed on the shelf. Each electronic shelf label 2 shows article information such as the article name and unit price of the corresponding article. The electronic shelf labels 2 are grouped in plural groups (in FIG. 1, three groups A, B and C). The electronic shelf labels 2 communicate with the shelf label server 1, with each group using a common wireless base station 4.

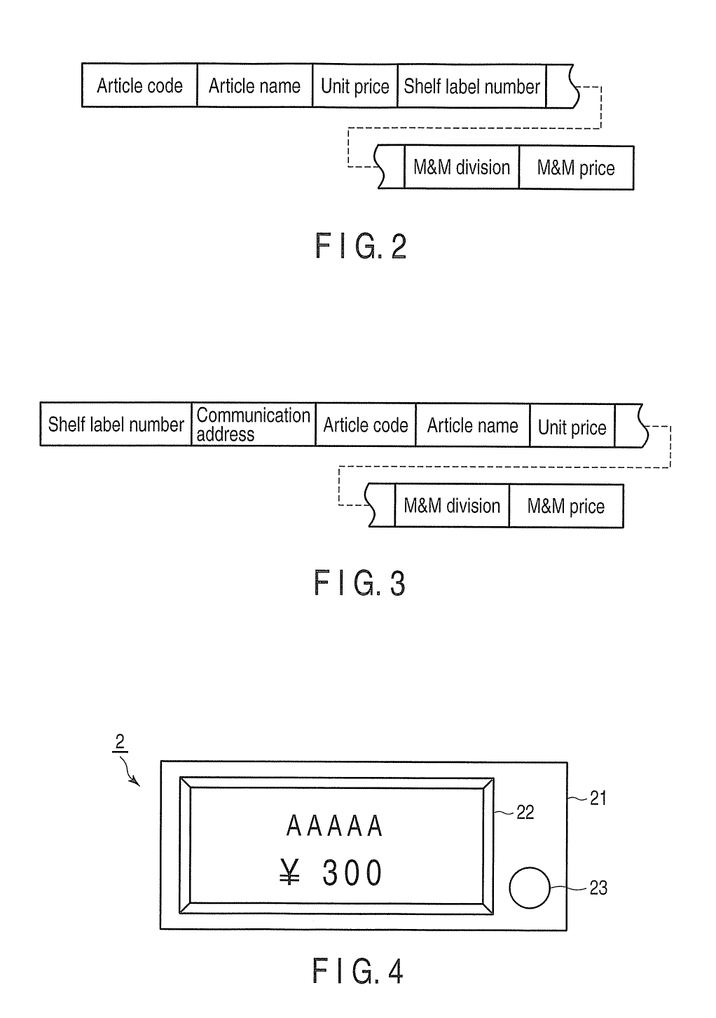

The POS server 5 accesses an article information database 7. In the article information database 7, article setting information created for each article is stored. The article setting information includes data items such as article code, article name, unit price, shelf label number, M&M division, and M&M price, as shown in FIG. 2.

The shelf label server 1 accesses a shelf label information database 8. In the shelf label information database 8, shelf label setting information created for each electronic shelf label 2 is stored. The shelf label setting information includes data items such as shelf label number, communication address, article code, article name, unit price, M&M division, and M&M price, as shown in FIG. 3.

An article code is article identification information to specify each article individually. A shelf label number is shelf label identification information to specify each electronic shelf label 2 individually. A communication address is the identification address of the wireless base station 4 connectable with the electronic shelf label 2 specified by the corresponding shelf label number. An M&M division is group identification information to identity whether the article specified by the corresponding article code is an M&M target article or not. M&M divisions have different values (except “0”) for different groups in bulk sale. An M&M price is the selling price where bulk sale is concluded for the group classified by the corresponding M&M division. For M&M non-target articles, both the M&M division and M&M price have “0”.

Here, an area in the shelf label information database 8 where the article name, unit price and M&M price are stored forms a first storage unit. An area in the database 8 where the M&M division is stored forms a second storage unit.

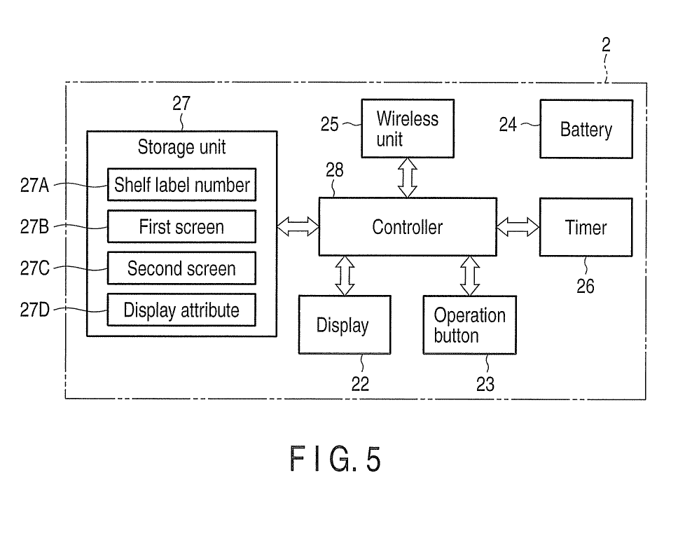

FIG. 4 shows a front view of the electronic shelf label 2. FIG. 5 shows a block diagram of the electronic shelf label 2. The electronic shelf label 2 is provided with a display 22 and an operation button 23 on the front side of a thin plate-like casing 21. The electronic shelf label 2 also has a battery 24 as a driving source, a wireless unit 25 to communicate with the wireless base station 4, a timer 26, a non-volatile storage unit 27 and a controller 28 which controls each part, within the casing 21.

In the storage unit 27, a shelf label number area 27A, a first screen area 27B, a second screen area 27C and a display attribute area 27D are formed. In the shelf label number area 27A, a shelf label number that is preset for the electronic shelf label 2 in question is stored. In the first screen area 27B, information of a first screen is stored. In the second screen area 27C, information of a second screen is stored. Both the first screen and the second screen are displayed on the display 22. In the display attribute area 27D, display attribute information to specify the display form on the display 22 is stored.

The display 22 displays character information such as article name and unit price. On the display 22, the background color of the screen where the character information is displayed changes according to the display attribute information. The background color is, for example, red, blue, yellow, green or the like. The default background color is white.

The display 22 displays the information of the first screen in normal time. As the operation button 23 is pressed, the display 22 displays the information of the second screen while the operation button 23 is kept pressed. The information of the first screen includes article name and normal price. In the case of an M&M target article, the information of the second screen includes M&M price. The information of the first screen and the second screen is not limited to the above.

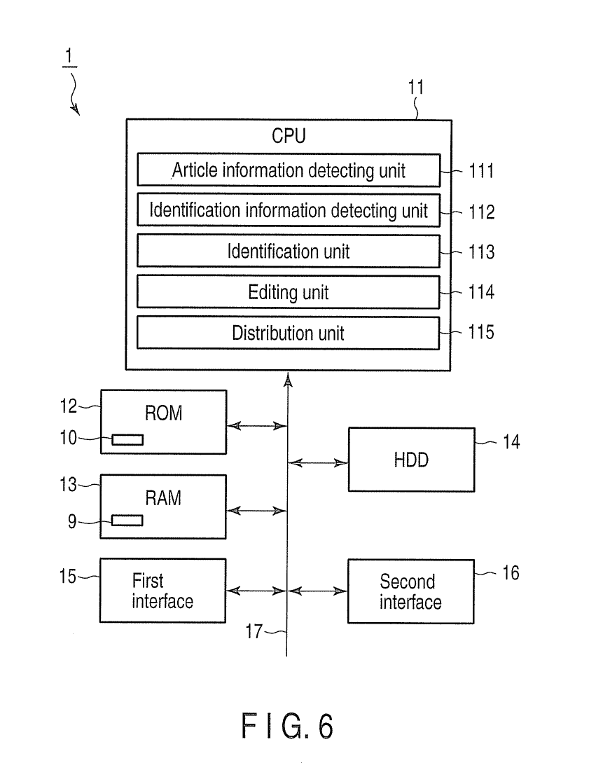

FIG. 6 is a block diagram showing the main configuration of the shelf label server 1. The shelf label server 1 is a computer device having a CPU (central processing unit) 11, a ROM (read only memory) 12 and a RAM (random access memory) 13. The shelf label server 1 also includes an HDD (hard disk drive) device 14, a first interface 15 and a second interface 16. The CPU 11 connects the ROM 12, the RAM 13, the HDD device 14, the first interface 15 and the second interface 16 via a bus line 17 such as an address bus or data bus.

In the HDD device 14 as an auxiliary storage unit, the shelf label information database 8 is saved. The first interface 15 communicates with the electronic shelf labels 2 connected via the first network 3 and the wireless base stations 4. The second interface 16 communicates with the POS server 5 connected via the second network 6.

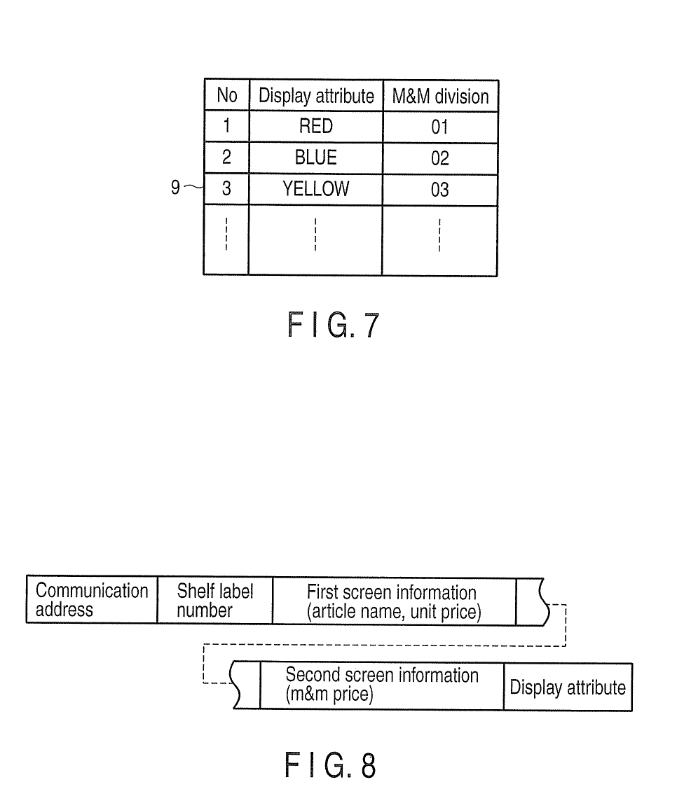

A conversion table 9 is stored in the RAM 13. In the conversion table 9, a different M&M division value is stored for each display attribute information that can be set for the electronic shelf labels 2, as shown in FIG. 7. In the conversion table 9, an M&M division value “01” is set for display attribute information [RED] indicating the background color of red. An M&M division value “02” is set for display attribute information [BLUE] indicating the background color of blue. An M&M division value “03” is set for display attribute information [YELLOW] indicating the background color of yellow. Such a conversion table 9 is created, for example by the POS server 5 and downloaded to the shelf label server 1 via the second network 6.

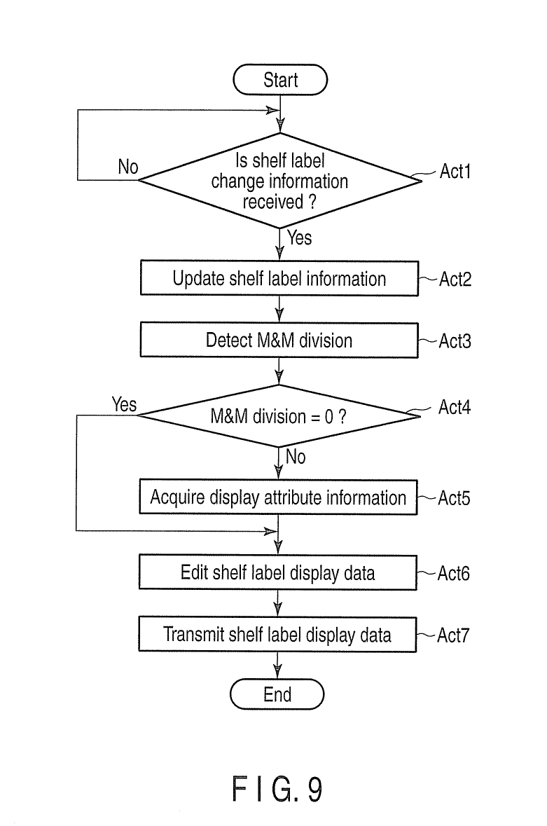

In the ROM 12, an electronic shelf label control program 10 to control screen information displayed on the electronic shelf labels 2 is stored. This program 10 causes the CPU 11 to function as an article information detecting unit 111, an identification information detecting unit 112, an identification unit 113, an editing unit 114 and a distribution unit 115. These functions will be described with reference to the flowchart of FIG. 9.

FIG. 9 is a flowchart showing processing procedures executed by the CPU 11 according to the program 10. As the program 10 is started, the CPU 11 determines whether shelf label change information is received or not (ACT 1). When shelf label change information is not received (NO in ACT 1), the CPU 11 waits for the information to be received.

In a store where the electronic shelf label system 100 is constructed, when the price of an article is changed, the user changes the unit price of the article setting information stored in the article information database 7 of the POS server 5. When the place where the article is placed is changed, the user changes the shelf label number of the article setting information. When the article becomes an M&M target or a non-target, the user changes the information of M&M division and M&M price of the article setting information.

When at least one item of the unit price, shelf label number, M&M division and M&M price is changed, the POS server 5 transmits shelf label change information including the changed article setting information to the shelf label server 1.

When the shelf label change information is received via the second interface 16 (YES in ACT 1), the CPU 11 updates the shelf label setting information corresponding to the received shelf label change information. That is, the CPU 11 detects the shelf label number from the shelf label change information. The CPU 11 then rewrites the article code, article name, unit price, M&M division and M&M price of the shelf label setting information on which this shelf label number is set, to the information of the same items in the shelf label change information (ACT 2: article information detecting unit 111).

Next, the CPU 111 detects the M&M division from the updated shelf label setting information (ACT 3: identification information detecting unit 112). The CPU 11 then determines whether this M&M division has a value “0” indicating an M&M non-target or not (ACT 4: identification unit 113).

When the article whose article information is displayed on the electronic shelf label 2 with the updated shelf label setting information is an M&M target article, the value of M&M division is not “0” (NO in ACT 4). In this case, the CPU 11 searches the conversion table 9 in order to acquire the display attribute information that is set corresponding to the M&M division of the shelf label setting information (ACT 5). After acquiring the display attribute information, the CPU 11 edits shelf label display data including this display attribute information (ACT 6: editing unit 114).

When the article whose article information is displayed on the electronic shelf label 2 with the updated shelf label setting information is an M&M non-target article, the value of M&M division is “0” (YES in ACT 4). In this case, the CPU 11 edits the shelf label display data without searching the conversion table 9 (ACT 6).

FIG. 8 shows the structure of the shelf label display data. The CPU 11 detects the communication address and the shelf label number from the shelf label setting information. The communication address and the shelf label number are used as head data of the shelf label display data. The CPU 11 also detects the article name and the unit price from the shelf label setting information. The article name and the unit price are used as first screen information. The CPU 11 also detects the M&M price from the shelf label setting information. The M&M price is used as second screen information.

The CPU 11 adds the first screen information and the second screen information to the header data, and also adds the display attribute information if the display attribute information is acquired in the processing of ACT 5, and thus forms the shelf label display data. The CPU 11 distributes the shelf label display data to the electronic shelf label 2 via the first interface 15 (ACT 7: distribution unit 115).

The shelf label display data is transmitted via wireless from the wireless base station 4 designated by the communication address in the header data. The shelf label display data is received by the electronic shelf label 2 on which the shelf label number in the header data is set.

The controller 28 of the electronic shelf label 2 that receives the shelf label display data saves the first screen information, the second screen information and the display attribute information of the shelf label display data to overwrite the existing data in the first screen area 27B, the second screen area 27C and the display attribute area 27D in the storage unit 27.

After that, the controller 28 displays the first screen information stored in the first screen area 27B, on the display 22 in the display form specified by the display attribute information stored in the display attribute area 27D. When the operation button 23 is inputted, the controller 28 displays the second screen information stored in the second screen area 27C, on the display 22 in the display form specified by the display attribute information stored in the display attribute area 27D during the period when the operation button is kept pressed. Besides, when the operation button 23 is inputted, the second screen information may be displayed in default display form.

In the electronic shelf label system 100 with such configuration, the background color on the display 22 of the electronic shelf label 2 corresponding to an M&M non-target article is the default color of white. The article name and price of the article are displayed on the display 22. On the other hand, the background color on the display 22 of the electronic shelf label 2 corresponding to an M&M target article is designated by the display attribute information. The article name and price of the article are displayed on the display 22.

For example, as an M&M division “01”, an assumption is made that “An article ‘AAAAA’ and an article ‘BBBBB’ cost ¥300 each but bulk purchase of the two costs ¥500.” The display attribute information for the M&M division “01” is assumed to be [RED].

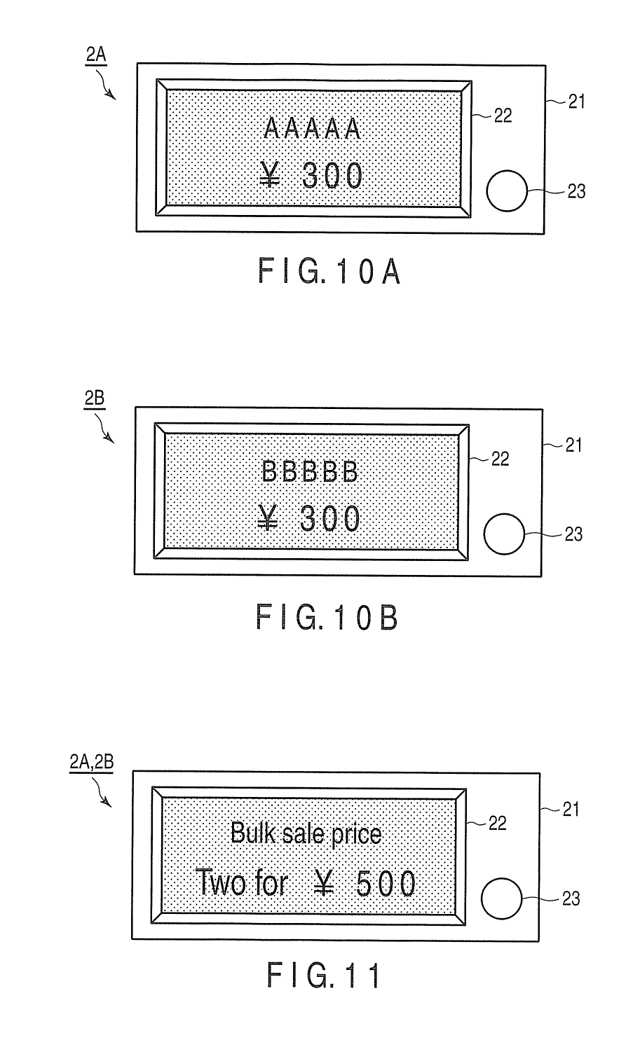

In this case, as the first screen on an electronic shelf label 2A corresponding to the article ‘AAAAA’, the article name ‘AAAAA’ and the price ‘¥300’ are displayed on the display 22 with the background color of red, as shown in FIG. 10A. Similarly, as the first screen on an electronic shelf label 2B corresponding to the article ‘BBBBB’, the article name ‘BBBBB’ and the price ‘¥300’ are displayed on the display 22 with the background color of red, as shown in FIG. 10B. Here, for example, a POP (point of purchase) advertisement showing that “articles having the same background color displayed on the electronic shelf labels are M&M target articles” is posted to inform shoppers.

Thus, the shopper can easily learn that the article ‘AAAAA’ and the article ‘BBBBB’ with the background color of red displayed on the electronic shelf labels 2A and 2B are M&M target articles.

The shopper, recognizing that the articles ‘AAAAA’ and ‘BBBBB’ are M&M target articles, inputs the operation button 23 on the electronic shelf label 2A or the electronic shelf label 2B. During this time, the display 22 on the electronic shelf label 2A or the electronic shelf label 2B switches to the second screen showing the M&M price is two for ¥500, as shown in FIG. 11.

In this manner, according to the embodiment, the background color on the electronic shelf label 2 is different between M&M target articles and non-target articles. Therefore, the shopper can easily discriminate whether an article is an M&M target article or not, simply by looking at the electronic shelf label 2.

When articles are M&M target articles but in different groups, the background color on the electronic shelf label 2 is different. Therefore, the shopper can easily identify the same M&M target articles and different M&M target articles, simply by looking at the electronic shelf labels 2.

In the embodiment, the display attribute information is the information to designate the background color on the display 22. By differentiating the background color, M&M target articles and non-target articles can be identified. However, the display attribute information is not limited to the information to designate the background color. Hereinafter, other embodiments of the display attribute information will be described.

### Second Embodiment

In a second embodiment, the display attribute information is information to designate the color of characters displayed on the display 22. That is, the color of characters displayed on the display 22 of the electronic shelf label 2 is changed to various colors such as red, blue, yellow and green according to the display attribute information stored in the display attribute area 27D. The other parts of the configuration are similar to the first embodiment.

### Third Embodiment

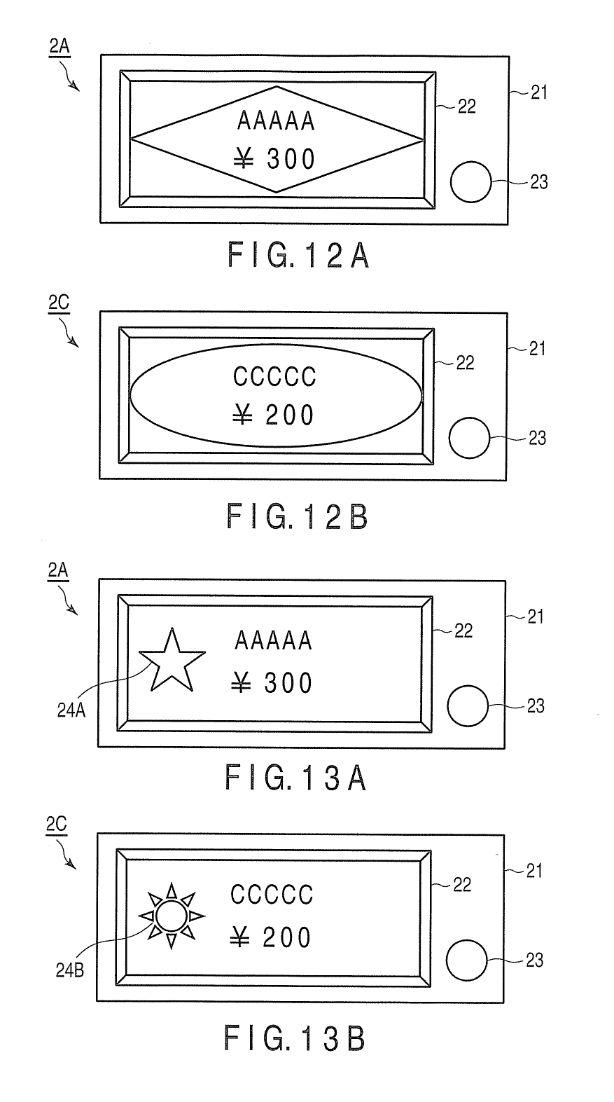

In a third embodiment, the display attribute information is information to designate the shape of a frame surrounding the article information displayed on the display 22. That is, the article information such as article name and price on the electronic shelf label 2 is surrounded by a rhombic, elliptic or like frame, as shown in FIG. 12A or FIG. 12B, according to the display attribute information stored in the display attribute area 27D.

### Fourth Embodiment

In a fourth embodiment, the display attribute information is information to designate a mark displayed on the display 22. That is, a star mark 24A, a sun mark 24B or the like is displayed on the display 22 together with the article name, price and the like, as shown in FIG. 13A or FIG. 13B, according to the display attribute information stored in the display attribute area 27D.

As a matter of course, these second to fourth embodiments have similar effects to the first embodiment.

In the third embodiment, the background color as well as the frame may be changed according to the display attribute information. Similarly, the color of characters as well as the frame may be changed according to the display attribute information. In the fourth embodiment, the background color as well as the mark may be changed according to the display attribute information. Similarly, the color of characters as well as the mark can be changed according to the display attribute information.

The invention is not limited to the embodiments.

For example, in a supermarket where a point service system is introduced, a service to set a point multiplication rate for multiplying normal points by n (n being 2 or greater) for certain articles is implemented in some cases. Thus, plural articles to which the point multiplication rate for multiplying normal points by n is applied are grouped. The display form on the electronic shelf label 2 displaying information about the article belonging to this group may be made different from the display form of articles that do not belong to the group.

In the embodiments, the first screen and the second screen are switched by the operation button 23. However, the switching is not limited to this technique. For example, the first screen and the second screen may be automatically switched every time the timer 26 measures a predetermined time. In this case, the display time of the first screen and the display time of the second screen may be made different. Moreover, the second screen need not necessarily be provided when a POP advertisement shows the bulk sale price as in conventional examples.

In the embodiments, the case is described where the program 20 to carry out the embodiment is recorded in advance in the ROM 12 of the shelf label server 1. However, without being limited to this case, the program 20 may be downloaded to the server 1 from a network. Alternatively, a recording medium in which the similar program 20 is stored may be installed in the server 1. As the recording medium, any form of recording medium in which a program can be stored and which can be read by the server 1, such as a CD-ROM, can be employed. The functions acquired by installation or download in advance may be realized in cooperation with the OS (operating system) within the server 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic shelf label control apparatus comprising:
an article information detecting unit configured to detect, according to each shelf label identification information to specify plural electronic shelf labels individually, article information displayed on the electronic shelf labels specified by the shelf label identification information;
an identification information detecting unit configured to detect, according to this each shelf label identification information, group identification information to identify whether articles having the article information displayed on the electronic shelf labels specified by the shelf label identification information belong to a same group or not; and
a distribution unit configured to distribute display attribute information to differentiate display forms of the article information between articles belonging to the same group and articles that do not belong to the same group, to the electronic shelf label specified by the shelf label identification information corresponding to the article information of each of the articles identified as articles belonging to the same group from based on the group identification information.

2. The apparatus of claim 1, wherein the group identification information can identify plural groups, and
the distribution unit distributes the display attribute information to differentiate the display form of the article information for each different group.

3. The apparatus of claim 2, wherein the display attribute information is information to designate a background color in an article information display area on the electronic shelf label.

4. The apparatus of claim 2, wherein the display attribute information is information to designate a color of characters in an article information display area on the electronic shelf label.

5. The apparatus of claim 2, wherein the display attribute information is information to designate a shape of a frame surrounding information displayed in an article information display area on the electronic shelf label.

6. The apparatus of claim 2, wherein the display attribute information is information to designate a mark displayed in an article information display area on the electronic shelf label.

7. The apparatus of claim 1, further comprising an identification unit configured to identify articles belonging to the same group and articles that do not belong to the same group based on the group identification information detected by the identification information detecting unit.

8. The apparatus of claim 7, further comprising an editing unit configured to add the display attribute information to article information of the articles identified by the identification unit as belonging to the same group,
wherein the distribution unit distribute the information edited by the editing unit.

9. The apparatus of claim 2, further comprising an identification unit configured to identify articles belonging to the same group and articles that do not belong to the same group based on the group identification information detected by the identification information detecting unit.

10. The apparatus of claim 9, further comprising an editing unit configured to add, to article information of the articles identified by the identification unit as belonging to the same group, the display attribute information that is different from information added to the articles identified as belonging to a different group,
wherein the distribution unit distribute the information edited by the editing unit.

11. An electronic shelf label control method comprising:
detecting, according to each shelf label identification information to specify plural electronic shelf labels individually, article information displayed on the electronic shelf labels specified by the shelf label identification information;
detecting, according to this each shelf label identification information, group identification information to identify whether articles having the article information displayed on the electronic shelf labels specified by the shelf label identification information belong to a same group or not;
identifying articles belonging to the same group and articles that do not belong to the same group, based on the group identification information; and
distributing display attribute information to differentiate display forms of the article information between the articles belonging to the same group and the articles that do not belong to the same group, to the electronic shelf label specified by the shelf label identification information corresponding to the article information of each of the articles identified as articles belonging to the same group from based on the group identification information.
